(19) United States
(12) Patent Application Publication
(10) Pub. No.: US 2014/0181500 A1
(43) Pub. Date: Jun. 26, 2014

(54) BIOS Network Access

(71) Applicants: James M. Mann, Cypress, TX (US); Valiuddin Y. Ali, Cypress, TX (US)

(72) Inventors: James M. Mann, Cypress, TX (US); Valiuddin Y. Ali, Cypress, TX (US)

(21) Appl. No.: 14/238,987

(22) PCT Filed: Aug. 30, 2011
(86) PCT No.: PCT/US2011/049733

§ 371 Date: Feb. 14, 2014

(51) Int. Cl. G06F 9/44

(52) U.S. Cl. CPC G06F 9/4416
USPC 713/2

(57) ABSTRACT

Embodiments provide devices and operations which enable a computing device to access a network. The computing device may execute a basic input/output system (BIOS). In response to the BIOS, the computing device may establish a wireless link with a client device and receive, from the client device, network access information.

### BACKGROUND

A Basic Input/Output System (BIOS) includes programming instructions stored in a memory of a computing device. The BIOS generally performs tasks related to the initialization of the computing device. For example, when a computing device is started, a processor or controller will execute instructions of the BIOS to initialize the motherboard, the video graphics cards, and other components. The BIOS may ensure the components are functioning properly, and subsequently, pass control of the computing device to an operating system.

### BRIEF DESCRIPTION OF THE DRAWINGS

FIG. 1 illustrates an apparatus in accordance with an example of the present disclosure;

FIG. 2 illustrates an apparatus in accordance with an example of the present disclosure;

FIG. 3 illustrates a network diagram in accordance with an example of the present disclosure;

FIG. 4 illustrates a block diagram of an operation in accordance with an example of the present disclosure; and

FIGS. 5-8 illustrate flow diagrams in accordance with examples of the present disclosure.

### DETAILED DESCRIPTION

Network access is generally established under the control of an operating system (OS). For example, an OS may load a program that controls hardware, identifies available wireless networks, seeks credentials to access wireless networks, and displays signal strengths, among other things. Accessing a network through an OS, however, may expose user inputs, such as passwords, to ill-intentioned people, for example, through malware.

In the present disclosure, various apparatuses, methods, and articles of manufacture are disclosed that enable a computing device to establish network access in a pre-operating system (OS) state. A pre-OS state is a computing state in which the runtime OS has not been loaded, for example when the computing device is executing instructions of a Unified Extensible Firmware Interface (UEFI), a Basic Input/Output System (BIOS), or other pre-OS program. Establishing network access in a pre-OS state prevents the exposure of passwords and credentials to malware due to the isolated environment of the pre-OS programs.

While establishing network access in a pre-OS state may provide security, it additionally allows a computing device with a malfunctioning pre-OS program, for example a corrupted BIOS, to retrieve, update, and/or repair itself. A corrupted BIOS, as used herein, is a BIOS program having a code section incapable of performing intended functions, but having a valid boot block. A boot block is a portion of the BIOS that verifies the code section of the BIOS is intact before transferring control to the code section. The remainder of the present disclosure will make reference to a BIOS, but it is expressly contemplated that the teachings herein may be applied to other pre-OS programs. Once repaired or updated, the computing device may load an OS and continue operation while maintaining network connectivity.

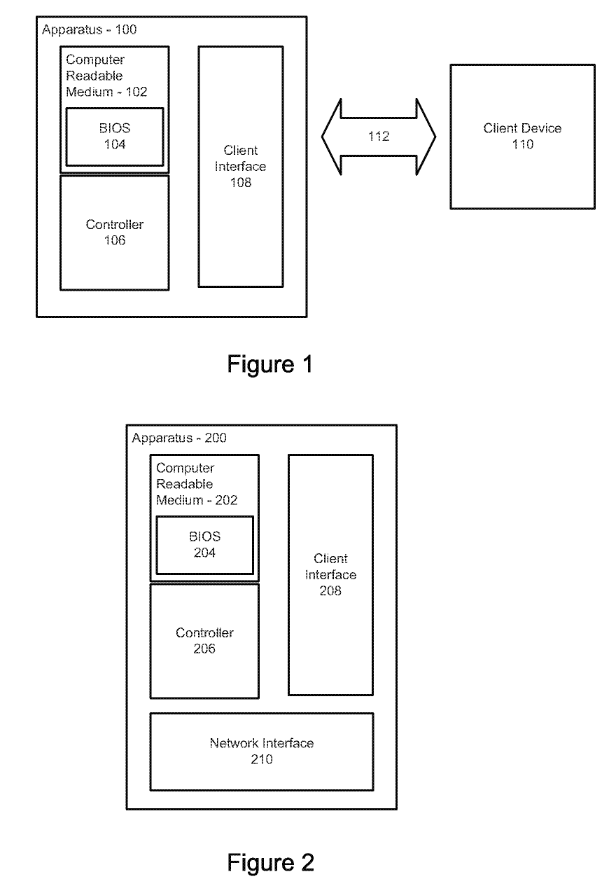

Referring to FIG. 1, an apparatus is illustrated in accordance with an example of the present disclosure. The apparatus 100 includes computer readable medium 102 having a BIOS 104, a client interface 108, and a controller 106. The apparatus 100 is to establish a network connection in a pre-OS state. The network connection may be utilized while in the pre-OS state, and additionally, may persist during the runtime of the OS. The apparatus 100 may be a device such as, but not limited to, a desktop computer, a notebook computer, a netbook, a slate, a tablet, or another computing device incorporating a BIOS.

Computer readable medium 102 is a tangible, non-transitory medium that stores an instruction which is executable by a processor or controller to enable the apparatus 100 to perform various operations. The computer readable medium 102 may also be used to store data. In the illustrated example, computer readable medium 102 is a memory including a BIOS. The BIOS includes instructions to be executed by the apparatus 100 to establish a network connection.

Client interface 108 is coupled to the computer readable medium 102. The client interface 108 is an interface configured to wirelessly communicate with a client device 110. Examples of client interfaces include Bluetooth devices, near field communications (NFC) devices, wireless local area network (WLAN) devices, among others. The client interface 108 may be initialized and controlled by controller 106 executing instructions of the BIOS 104.

Controller 106 may be a processor, microcontroller, or other component configured to execute one or more instructions, for example the instructions embodied in BIOS 104. The controller 106 may include additional components beyond those illustrated in FIG. 1 without deviating from the present disclosure.

In an example, apparatus 100 may be in a pre-OS state. The apparatus 100 may be present within a wireless environment such as a wireless local area network, a metropolitan area network, or another wireless network. Prior to the OS loading, the apparatus 100, via controller 106, may execute instructions embodied in the BIOS 104 stored in computer readable medium 102. In response to the executed instructions embodied in the BIOS 104, the apparatus 100 may attempt to establish a network connection.

In various wireless environments, network access information is utilized to establish a wireless link. Network access information is data that enables a computing device to access a network. Examples of network access information include, but are not limited to, Service Set Identifiers (SSIDs), Wired Equivalent Privacy (WEP) key, Internet Protocol (IP) address, security information, user information, and/or credential information, among others. To establish a wireless link in a pre-OS state, the controller 106 may determine whether the network access information is available in local memory.

If network access information is not available in local memory, for example, if apparatus 100 is in a new wireless network, or a credential has changed since the apparatus 100 last accessed the wireless network, the controller 106 may attempt to obtain the network access information from a client device 110. A client device 110 may be a secondary device having a user interface or the network access information. Client device 110 may be a computing device such as, but not limited to, a smart phone, a computer, a notebook, a netbook, a slate, a tablet, or another computing device that is operational.

The apparatus 100, via the client interface 108, is to wirelessly communicate with a client device 110 to receive the network access information. Establishing the wireless connection 112 may include the initialization of hardware by the BIOS 104, for example, initialization of the client interface 108. With the wireless connection 112 established, the client device 110 may transfer the network access information to the apparatus 100.

Wireless connection 112 and associated interfaces of apparatus 100 and client device 110 may utilize various technologies. In one example, client interface 108 may utilize NFC technology such that when client device 110 is brought within a preset distance of apparatus 100 the network access information is transferred. This NFC technology may be initiated via “tap to share” functionality. In another example, the client interface 108 may utilize Bluetooth technology. In this example, dynamic pairing of the apparatus 100 with the client device 110 may occur through a Bluetooth pairing mechanism. In another example, the apparatus 100 may utilize a Bluetooth Human Interface Device (HID) profile to allow a user to enter information via the client device 110. Other mechanisms are contemplated.

The controller 106, executing instructions associated with the BIOS is to control receipt of the network access information from a client device 110. The controller 106 may utilize the network access information to establish a wireless link based on the network access information. The wireless link may occur between a network access point and the apparatus 100, or alternatively, a tethering device and the apparatus 100. A tethering device is a device which enables the apparatus 100 to access a network (e.g. the Internet) via a network connection of the tether device. In various examples, the client device 110 may be utilized as a tethering device.

Referring to FIG. 2, another example of an apparatus is illustrated in accordance with the present disclosure. The apparatus 200 includes memory or computer readable medium 202 with a BIOS 204, a controller 206, a client interface 208, and a network interface 210. In the illustrated example, the computer readable medium 202, BIOS 204, controller 206, and client interface 208 may be similar to the components illustrated in FIG. 1. The apparatus 200 may be a computing device such as a computer, a notebook computer, a netbook, or another data processing device configured to utilize a BIOS.

The network interface 210 is a component configured to provide network access to apparatus 200. The network interface 210 may interface with a network access point and establish a wireless link with the network access point. A network access point may be any device configured to provide access to a network such as the Internet. The network access point may request various credentials prior to enabling access, such as a password or other credential (e.g. network access information). Based on receipt of the password or credential, the network access point may enable an apparatus to transmit and receive data packets.

In various examples, once network access has been established, the apparatus 200 via the BIOS 204 may load and execute an operating system. The network access may persist while the operating system is executing. In one example, prior to loading the operating system, the apparatus 200 may retrieve a BIOS from a remote server via the network access point. The retrieved BIOS may be an updated or working version of the BIOS. Once retrieved, the apparatus 200 may store the BIOS in a memory and replace the BIOS 204 with either an updated version or working version of the BIOS. In this manner, the apparatus 200 may be configured to replace or update a BIOS that is outdated, corrupted, or otherwise in a non-working condition.

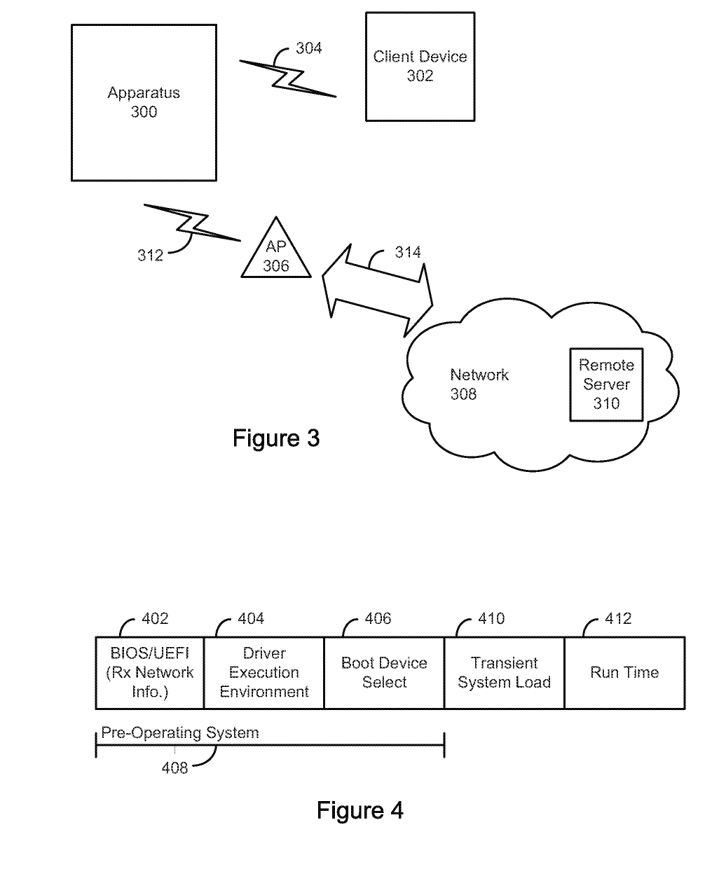

Referring now to FIG. 3, a network diagram is illustrated in accordance with the present disclosure. The network diagram includes a client device 302, an apparatus 300, an access point 306, and a remote server 310 disposed on a network 308. The apparatus 300 may be an apparatus similar to those discussed with reference to FIG. 1 or 2.

In the illustrated example, the apparatus 300 may be in a pre-OS state, for example, the apparatus 300 may be executing instructions that implement a BIOS. The apparatus 300 may have a corrupted BIOS which prevents the apparatus 300 from loading an operating system. A corrupted BIOS is a BIOS that includes a corrupted instruction in the BIOS code, but has a valid boot block. The apparatus 300, via the valid boot block of the BIOS, may establish a wireless connection 304 with client device 302. The wireless connection 304 may be a NFC connection, a Bluetooth connection, or another wireless connection. Based on the wireless connection 304, the apparatus 300 may receive network access information.

The network access information received from the client device 302 may be associated with access point 306. For example, the network access information may include user credentials necessary for establishing a wireless connection with the network access point. In response to receipt of the network access information, the apparatus 300, while in a pre-OS state, may establish a wireless connection 312 with the network access point 306. Once established, the apparatus may utilize the network access information to establish a wireless connection with a remote server 310 disposed on network 308 via communications 312 and 314.

Once the wireless connection is established, the apparatus 300 may retrieve an updated or valid BIOS from the remote server 310 via the network access point 306 and network 308. The BIOS may include a location of the remote server, for example, a web address of the remote server 310, in the boot block code, thereby preserving the ability of the BIOS to locate the remote server 310. The apparatus 300 may then replace any corrupted or current BIOS with the retrieved BIOS. Once replaced, the apparatus may load an OS. The wireless connection 312 with AP 306 may persist after execution of the operating system.

Referring to FIG. 4, an example block diagram of various stages associated with a computing device is illustrated. The block diagram illustrates possible initial stages of execution including a BIOS and an operating system. Upon powering of the computing device and overcoming any implemented security, a BIOS or UEFI may be loaded and executed at 402. Once executing, the BIOS may control of various operations and may initialize various hardware components and associated drivers to implement a wireless network connection. Implementation of the wireless network connection may include initialization of a client interface, drivers, and software. The initialization of the components may facilitate receipt of network access information from the client device.

After receipt of network access and verification of various hardware, the BIOS may initialize various drivers in the driver execution environment 404. Once initialized, the BIOS may select a device from which to load an operating system. In various embodiments the operating system may be retrieved from a hard drive. After selection of a boot device at 406, the system may begin the transient system load at 410. During the transient system load, operation of the computing device begins to transition to an operating system. At 412, run time is monitored and controlled through the operating system. In one example, components 402-406 are identified as being pre-OS 408.

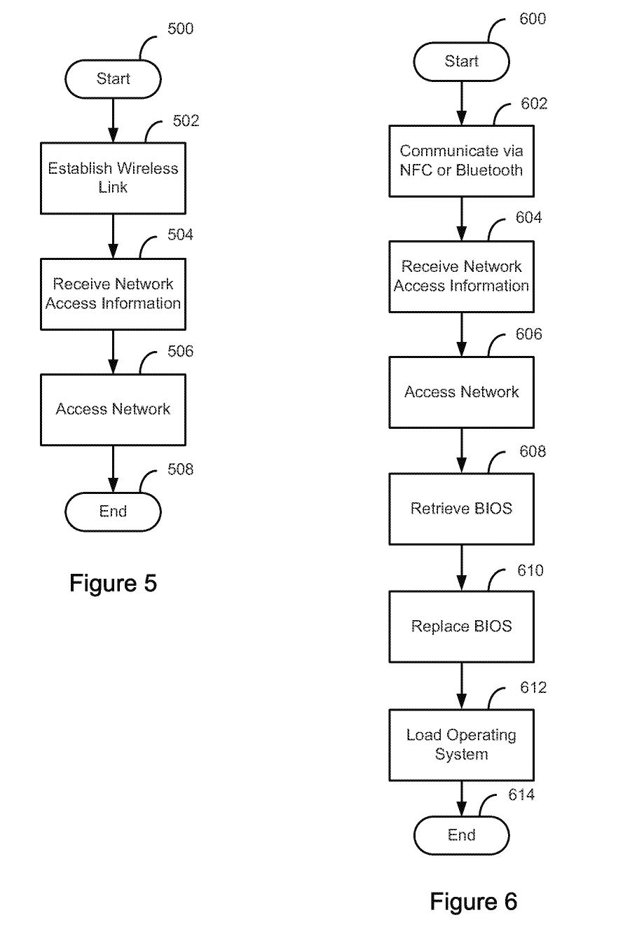

Referring to FIG. 5, an example flow diagram is illustrated in accordance with the present disclosure. The flow diagram may begin at 500 and progress to 502 where an apparatus, for example, an apparatus as described with reference to FIG. 1 or 2 establishes a wireless link with a client device in response to execution of an instruction of a BIOS. The instruction may be executed by a controller of the apparatus.

In response to the establishment of a wireless link, the apparatus may receive network access information from the client device at 504. Receipt of network access information may be in response to a request for the network access information, or alternatively, may be in response to the apparatus establishing the link at 502.

At 506, the apparatus may access a network based on the network access information. The access may occur through a network access point, or alternatively, through the client device in which the network access information was received, for example, by using the client device as a tethering device. Upon access of the network, the method may end at 508.

Referring to FIG. 6, another flow diagram is illustrated in accordance with the present disclosure. The method may start at 600 and progress to 602 where an apparatus may establish a wireless link with a client device. To establish the wireless link, the apparatus may communicate with the client device. In one example, the apparatus may communicate with the client device via near field communication (NFC). In another example, the apparatus may communicate with the client device via a Bluetooth transmission.

In response to the communication, the apparatus may receive network access information at 604. In one example, the apparatus may establish a link with the client device and implement a Bluetooth human interface device (HID) profile in which the apparatus utilizes a keyboard of the client device to receive a string of characters. The string of characters may be received in response to a prompt for information such as user credentials and/or passwords.

Based on the received network access information, the apparatus may access a network at 606. Access of the network may be via a network access point such as a wireless local area network router, a base station, or other access point. Alternatively, the apparatus may access the network via a network connection of the client device.

In response to the network access, the apparatus may load an operating system. If, in various examples, the BIOS is corrupted such that the operating system or other components are not capable of being initialized, the apparatus via the network access, may retrieve an updated, uncorrupted, or new version of the BIOS at 608. To retrieve the BIOS, the apparatus may communicate with a remote server disposed on the network. The apparatus may store the retrieved BIOS in a memory and replace the corrupted or outdated BIOS at 610. To replace the BIOS, the apparatus may flash the BIOS.

With an updated BIOS loaded and capable of execution, the apparatus may then load an operating system in response to an instruction of the BIOS at 612. The method may then end at 614 as operation of the apparatus or computing device is handed to the operating system.

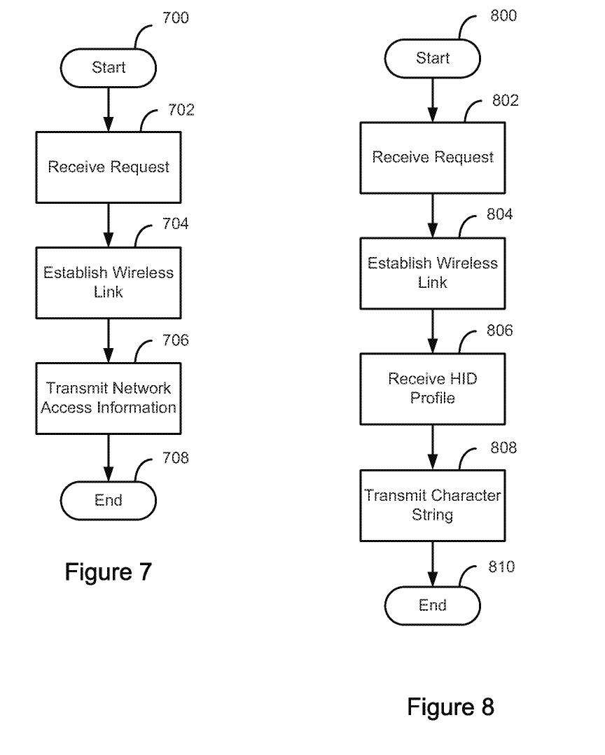

Referring to FIG. 7, a flow diagram associated with the operations of a client device is illustrated. The method may begin at 700 and progress to 702 where a client device may receive a request for a wireless link from a computing device, wherein the computing device is in a pre-OS system state.

In response to the received request, the client device may establish a wireless link with the computing device in the pre-OS state at 704. The wireless link may be established utilizing near filed communications, Bluetooth communications, or other protocols.

Based on the established wireless link, the client device may transmit network information to the computing device, wherein the network information may be utilized by the computing device to access a network at 706. The method may then end at 708.

Referring to FIG. 8, another flow diagram is illustrated in accordance with the present disclosure. The method may begin at 800 and progress to 802 where the client device may receive a request to establish a wireless link with a computing device. The computing device is in a pre-OS state and consequently, is unable to display information pertaining to the establishment of the wireless link. In one example, the request for the wireless link may occur via near field communication (NFC). In another example, the request for the wireless link may occur via a Bluetooth communication.

In response to the request, the client device may form a wireless link with the computing device at 804. The established wireless link may occur via various protocols including but not limited to, Bluetooth, NFC, or infrared. The established wireless link may occur without any intervention by a user of the computing device.

Once a wireless link has been established between the computing device and the client device, the client device may receive a Bluetooth HID profile at 806. The Bluetooth HID profile may allow a user to enter information on the client device and communicate the entered information to the computing device via a string of characters at 808. In response to the transmission of the network access information, the method may then end at 810.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope of this disclosure. Those with skill in the art will readily appreciate that embodiments may be implemented in a wide variety of ways. This application is intended to cover any adaptations or variations of the embodiments discussed herein. Therefore, it is manifestly intended that embodiments be limited only by the claims and the equivalents thereof.

What is claimed is:

1. An article of manufacture comprising a computer readable medium having basic input/output system (BIOS) stored thereon, wherein instructions of the BIOS, if executed, cause a computing device to:
establish a wireless link with a client device;
receive network access information from the client device via the wireless link: and
access a network based on the network access information.

2. The article of manufacture of claim 1, wherein the instructions of the BIOS, if executed, cause the computing device to:
communicate with the client device via near field communication (NFC) to establish the wireless link.

3. The article of manufacture of claim 1, wherein the instructions of the BIOS, if executed, cause the computing device to:
communicate with the client device via a Bluetooth transmission to establish the wireless link.

4. The article of manufacture of claim 1, wherein the instructions of the BIOS, if executed, further cause the computing device to:
retrieve another BIOS from a remote server via the network; and
replace the BIOS with the another BIOS.

5. The article of manufacture of claim 1, wherein the instructions of the BIOS, if executed, further cause the computing device to:
load an operating system.

6. The article of manufacture of claim 1, wherein the instructions of the BIOS, if executed, cause the computing device to:
receive the network access information via a keyboard of the client device.

7. An apparatus, comprising:
a memory, wherein the memory includes a basic input/output system (BIOS);
a client interface coupled to the memory, wherein the client interface is to wirelessly communicate with a client device to receive network access information associated with a network access point; and
a controller coupled to the client interface, wherein the controller is to execute instructions of the BIOS to control receipt of the network access information and establish a wireless link with a network access point based on the network access information.

8. The apparatus of claim 7, wherein the client interface is a near field communication device.

9. The apparatus of claim 7, wherein the client interface is a Bluetooth device.

10. The apparatus o claim 7, further comprising:
a network interface, wherein the network interface is to establish the wireless link with the network access point.

11. The apparatus of claim 7, wherein the controller is to execute another instruction of the BIOS to retrieve another BIOS from a remote server via the network access point, and replace the BIOS with the another BIOS.

12. A method, comprising:
receiving, by a client device, a request r a wireless link from a computing device, wherein the computing device is in a pre-operating system (OS) state;
establishing, by the client device, the wireless link with the computing device in the pre-OS state in response to receipt of the request; and
transmitting, by the client device, network access information via the wireless link.

13. The method of claim 12, wherein receiving the request for the wireless ink comprises receiving the request via a near field communication (NFC).

14. The method of claim 12, wherein receiving the request for the wireless link comprises receiving the request via a Bluetooth communication.

15. The method of claim 12, wherein transmitting the network access information comprises comprises receiving a Bluetooth Human interface Device (HID) profile.
